(19) United States
(12) Patent Application Publication
(10) Pub. No.: US 2004/0209967 A1
(43) Pub. Date: Oct. 21, 2004

(54) FLAME RETARDED STYRENIC POLYMER FOAMS

(76) Inventors: Paul F. Ranken, Baton Rouge, LA (US); Danielle F. Goossens, Nodebais (BE); Arthur G. Mack, Baton Rouge, LA (US); Dominique Fasbinder, Braives (BE)

Correspondence Address: EDGAR SPIELMAN, ALBEMARLE CORPORATION, 451 FLORIDA BLVD., BATON ROUGE, LA, 70801, US

(21) Appl. No.: 10/420,123

(22) Filed: Apr. 21, 2003

(51) Int. Cl. C08J 9/00

(52) U.S. Cl. 521/56; 521/82

(57) ABSTRACT

Styrenic polymer foams, especially XPS and EPS, are flame retarded by use of one or more flame retardant bis(bromoalkyl)bromophthalate additives, most preferably bis(2,3-dibromopropyl)tetrabromophthalate. Surprisingly, the distribution of EPS beads in the desired commercial size range was increased by the use of bis(2,3-dibromopropyl)tetrabromophthalate.

### BACKGROUND

Styrenic polymer foams such as extruded polystyrene foams (XPS) and expandable polystyrene foams (EPS) are in widespread use. In many cases it is desired to decrease the flammabilityof such products by incorporating a flame retardant therewith. It is desirable therefore to provide flame retardants that can be used in the production of both types of products.

Flame retardant extruded styrenic polymers such as XPS are typically made by mixing the styrenic polymer, a flame retardant, and a blowing agent in an extruder, and extruding the resultant mixturethrough a die providingthe desired dimensionsof the product, such as boards with various thicknesses and one of several different widths. For use in this process it is important that the flameretardant have good thermal stabilityand low corrosivity toward metals with which the hot blend comes into contact in the process. Also it is desirable that the flame retardant mix well with the other components in the extruder.

Flame retardant expandable styrenic polymers such as EPS are typically made by suspension polymerization of a mixture ofstyrene monomer(s) and flame retardant in water to form beads of styrenic polymer. The small beads (e.g., averaging about 1 mm in diameter) so formed are then pre-expanded with steam and then molded again with steam to produce large blocks which can be several meters high, and 2-3 meters wide, that will be cut in the desired dimensions. For use in this process it is desirable for the flame retardant to have at least some solubility in the styrenic monomer(s), especially in styrene.

While some brominated flame retardants have been proposed or used in extruded styrenic polymers such as XPS and/or in expandable styrenicpolymers such as EPS, typically high dosage levels of flameretardant have been required to achieve the desired effectiveness. The high cost of some of those flame retardants when coupled with the high dosage levels required for good effectiveness constitute a problem requiring an effective solution.

This invention provides novel flame retardants for use in expanded and extruded styrenic polymers.

### BRIEF SUMMARY OF THIS INVENTION

This invention provides styrenic polymer foams that are flame retarded by use of one or more bis(bromoalkyl)bromophthalateflame retardant additives. These compounds may be represented by the formula:

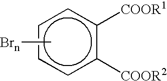

where each of R¹ and R² is, independently, a C₁₋₁₂ bromoalkyl group having in the range of 1 to about 4 bromine atoms as substituent(s) thereon, and n is from 1 to 4. Preferred flame retardant additives are those in which each of R¹ and R² is, independently, a C₃₋₆ bromoalkyl group having 2 or 3 bromine atoms as substituents thereon.

In a particularly preferred embodiment the additive is bis(2,3-dibromopropyl)tetrabromophthalate.

Another embodiment of this invention is a flame retardant styrenic polymer foam composition which comprises a styrenic polymer and flameretardant resulting from inclusion in the foam recipe before or during formation of the foam of at least one bis(bromoalkyl)bromophthalate flame retardant additive as described above, which flame retardant most preferably is bis(2,3-dibromopropyl)tetrabromophthalate.

The bis(bromoalkyl)bromophthalates have a desirable balance of aromatically-bonded bromine and aliphatically-bondedbromine in their structure. Without desiring to be bound by theory, it is believed that the presence of both aromatically-bonded bromine and aliphatically-bondedbromine is one of the features that contributes to their suitabilityfor use in both EPS-type and XPS-type styrenic polymers. In addition bis(bromoalkyl)bromophthalates such as bis(2,3-dibromopropyl)tetrabromophthalate are deemed advantageous because based on the present experience with bis(2,3-dibromopropyl)tetrabromophthalate, they should have good solubility in styrenicmonomers such as styrene, they should have adequate thermal stability for use in styrenic polymer foams, they should have desirable melting temperatures, and they shouldbe effective at low dosage levels. Moreover, at least in the case of bis(2,3-dibromopropyl)tetrabromophthalate, the practice of this invention is highly cost-effective. For example in the case of EPS, loadings of less than 1 wt % of bis(2,3-dibromopropyl)tetrabromophthalate have provided high yields of beads in the desired commercial size range. In fact as shown hereinafter, the distribution of beads in the commercially desirable range of from above 710 μm up to 2 mm was actually increased by the presence in the composition of at least some flame retardant amounts of bis(2,3-dibromopropyl)tetrabromophthalateas comparedto the samecomposition that was devoid of bis(2,3-dibromopropyl)tetrabromophthalate.

These and other embodiments and features ofthis invention will become still fuither apparent from the ensuing description.

### FURTHER DETAILED DESCRIPTION OF THE INVENTION

Styrenic Polymers

The styrenic polymer foams which are flame retarded pursuant to this invention are foamed (expanded) polymers of one or more polymerizable alkenyl aromatic compounds. The homopolymer or copolymer typically comprises in chemically combined form at least a major amount (by weight) of at least one alkenyl aromatic compound of the formula

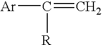

where Ar is an aromatic hydrocarbyl group which may be substituted by one or more chlorine and/or bromine atoms, and R is a hydrogen atom or a methyl group. Preferably the aromatic group Ar is not substituted by any halogen atom, and the styrenic polymer with which the bis(bromoalkyl)bromophthalate is blended in the practice of this invention does not contain halogen in the molecular structure of the polymer itself Examples of such styrenic polymers are homopolymers of styrene, alpha-methylstyrene, o-methylstyrene, m-methylstyrene, p-methylstyrene, ar-ethylstyrene, ar-vinylstyrene, ar-chlorostyrene, ar-bromostyrene, ar-propylstyrene, ar-isopropylstyrene, 4-tert-butylstyrene, o-methyl-alpha-methylstyrene, m-methyl-alpha-methylstyrene, p-methyl-alpha-methylstyrene, ar-ethyl-alpha-methylstyrene; and copolymers of two or more of such alkenyl aromatic compounds with minor amounts (by weight) of other readily polymerizable olefinic compounds such as, for example, methylmethacrylate,acrylonitrile,maleicanhydride, citraconic anhydride, itaconic anhydride, acrylic acid, vinyl carbazole, and rubber reinforced (either natural or synthetic) styrenic polymers. Preferably at least 80 weight % of styrene is incorporated in the styrenic copolymers. Thus in each and every embodimentof this invention set forth anywhere in this disclosure, including the claims, the styrenic polymer of the foam preferably comprises polystyrene or a styrenic copolymer in which atleast 80 wt % of the polymer is formed from styrene.

The styrenic polymers can be a substantially thermoplastic linear polymer or a mildly cross-linked styrenic polymer. Among suitable procedures that can be used for producing mildly cross-linked styrenic polymers for use in foaming operations are those set forth, for example, in U.S. Pat. Nos. 4,448,933; 4,532,264; 4,604,426; 4,663,360 and 4,714,716.

Methods for producing styrenic foams including both XPS foams and EPS foams are well known and reported in the literature. Thus any suitable method can be employed as long as the resultant foam is flame retarded by use of a flame retardant amount of a bis(bromoalkyl)bromophthalatepursuant to this invention. As a guide for dosage levels for use in foamed styrenic polymers, it is desirable to blend small amounts of the bis(2,3-dibromopropyl)polybromophthalate in unfoamedcrystal styrenic polymer and determine the LOI (Limited Oxygen Index) of molded test specimens made from the unfoamed blend. If such test specimens give an LOI that is at least one unit higher than a molded specimen of the same neat styrenic polymer, the dosage level should be suitable when used in the same foamed or foamable styrenic polymer. Typically the amount of bis(2,3-dibromopropyl)polybromophthalate used in the styrenic foams of this invention including both XPS foams and EPS foams is in the range of about 0.4 to about 6 wt %, and preferably in the range of about 0.7 to about 3 wt % based on the total weight of the foam composition.

Extruded Styrenic Foams

Flame retarded styrenic polymer foams can be prepared conveniently and expeditiously by use of known procedures. For example one useful general procedure involves heat plastifying a thermoplastic styrenic polymer composition of this invention in an extruder. From the extruder the heat plastified resin is passed into a mixer, such as a rotary mixer having a studded rotor encased within a housing which preferably has a studded internal surface that intermeshes with the studs onthe rotor. The heat-plastified resin and a volatile foaming or blowing agent are fed into the inlet end of the mixer and discharged from the outlet end, the flow being in a generally axial direction. From the mixer, the gel is passed through coolers and from the coolers to a die which extrudes a generally rectangular board. Such a procedure is described for example in U.S. Pat. No. 5,011,866. Other procedures include use of systems in which the foam is extruded and foamed under sub-atmospheric, atmospheric and super-atmospheric pressure conditions. As indicated in U.S. Pat. No. 5,011,866, one useful sub-atmospheric (vacuum) extrusion process is described in U.S. Pat. No. 3,704,083. This process is indicated to be of advantage in that the type of vacuum system therein described does not require a low-permeability/high permeability blowing agent mixture, due to the influence of the vacuum on the foaming process. Other disclosures of suitable foaming technology appear, for example, in U.S. Pat. Nos. 2,450,436; 2,669,751; 2,740,157; 2,769,804; 3,072,584; and 3,215,647.

Expandable Styrenic Beads or Granules

The styrenic polymer compositions of this invention can be used in the production of expandable beads or granules having enhanced flame resistance. In general, these materials may be produced by use of equipment, process techniques and process conditions previously developed for this purpose, since the flame retardant compositions of this invention do not materially affect adversely the processing characteristics and overall properties of the styrenic polymer employed. Also, known and established techniques for expandingthe expandablebeads or granules, and for moldingor formingthe further expanded beads or granules into desired products are deemed generally applicable to the expandable beads or granules formed from the styrenic polymer compositions of this invention. Suitable technology for producing expandablebeads or granules is disclosed, for example, in U.S. Pat. Nos. 2,681,321; 2,744,291; 2,779,062; 2,787,809; 2,950,261; 3,013,894; 3,086,885; 3,501,426; 3,663,466; 3,673,126; 3,793,242; 3,973,884; 4,459,373; 4,563,481; 4,990,539; 5,100,923; and 5,124,365. Procedures for converting expandable beads of styrenic polymers to foamed shapes is described, for example, in U.S. Pat. Nos. 3,674,387; 3,736,082; and 3,767,744.

Flame Retardants

The bis(bromoalkyl)bromophthalate(s) used in the practice of this invention can have 1, 2, 3, or most preferably 4 bromine atoms on the phthalate aromatic ring, and 1, 2, or 3 bromine atoms in each of the bromoalkyl groups. It is to be noted that the bromoalkyl ester groups are in adjacent positions on the aromatic ring, i.e., the flame retardants used in this invention are derivatives of phthalic acid, not isophthalic acid or terephthalic acid.

When the aromatic ring is substituted by less than 4 bromine atoms on the ing, the bromine atom(s) can occupy any available positionon the aromatic ring. Similarly when the bromoalkyl group has more than I carbon atom, the bromine atom(s) can occupy any available position on the straight or branched chain alkyl moiety. Conventional esterification procedures are available for use in preparing bis(bromoalkyl)bromophthalates.

Non-limiting examples bis(bromoalkyl)bromophthalates include bis(bromomethyl)-bromophthalate, bis(dibromomethyl)bromophthalate, bis(tribromomethyl)bromophthalate, bis(bromomethyl)dibromophthalatebis(bromomethyl)tribromophthalatebis(bromomethyl)-tetrabromophthalate, bis(dibromorrethyl)dibromophthalate, bis(tribromomethyl)dibromo-phthalate, bis(dibromomethyl)tribromophthalate, bis(tribromomethyl)tribromophthalate, bis(dibromomethyl)tetrabromophthalate, bis(tribromomethyl)tetrabromophthalate, and the higher monobromoalkyl, dibromoalkyl, and tribromoalkyl homologs of the foregoing compounds. Mixtures of two or more bis(bromoalkyl)bromophthalates can be used.

One group of compounds which are desirably used in the practice of this invention are the bromoneopentyl esters, especially bis(tribromoneopentyl)tetrabromophthalate described in U.S. Pat. No. 5,393,820 to Ashworth and Schneider, which compounds can be prepared as described therein.

Another group of compounds which are desirably used in the practice of this invention are the brominatedtetrabromophthalate esters, especially bis(2,3-dibromopropyl)-tetrabromophthalate, described in U.S. Pat. No. 5,824,241 to Horvat, which compounds can be prepared as described therein. Bis(2,3-dibromopropyl)tetrabromophthalate is preferred because of its great cost-effectiveness in the practice of this invention.

Foaming Agents

Any of a wide variety of known foaming agents or blowing agents can be used in producing the expanded or foamed flame resistant polymers of this invention. U.S. Pat. No. 3,960,792 gives a listing of some suitable materials. Generally speaking, volatile carbon-containing chemical substances are the most widely for this purpose. They include, for example, such materials as aliphatic hydrocarbons including etbane, ethylene, propane, propylene, butane, butylene, isobutane, pentane, neopentane, isopentane, hexane, heptane and mixtures thereof; volatile halocarbons and/or halohydrocarbons, such as methyl chloride, chlorofluoromethane, bromochlorodifluoromethane, 1,1,1-trifluoroethane, 1,1,1,2-tetrafluoroethane, dichlorofluoromethane,dichlorodifluoromethane,chlorotrifluoromethane, trichlorofluoromethane, sym-tetrachlorodifluoroethane, 1,2,2-trichloro-1,1,2-trifluoroethane, sym-dichlorotetrafluoroethane; volatile tetraalkylsilanes, such as tetramethylsilane, ethyltrimethylsilane, isopropyltrimethylsilane, and n-propyltrimethylsilane, and mixtures of such materials. One preferred fluorine-containing blowing agent is 1,1-difluoroethane also known as HFC-152a (FORMACEL Z-2, E.I. duPont de Nemours and Co.) because of its reported desirable ecological properties. Water-containing vegetable matter such as finely-divided corn cob can also be used as blowing agents. As described in U.S. Pat. No. 4,559,367, such vegetable matter can also serve as fillers. Use of carbon dioxide as a foaming agent, or at least a component of the blowing agent, is particularly preferred because of its innocuous nature vis-a-vis the environment and its low cost. Methods of using carbon dioxide as a blowing agent are described, for example, in U.S. Pat. No. 5,006,566 wherein the blowing agent is 80 to 100% by weight of carbon dioxide and from 0 to 20% by weight of one or more halohydrocarbons or hydrocarbons that are gaseous at room temperature, in U.S. Pat. Nos. 5,189,071 and 5,189,072 wherein a preferred blowing agent is carbon dioxide and 1-chloro-1,1-difluoroethane in weight ratios of 5/95 to 50/50, and in U.S. Pat. No. 5,380,767 wherein preferred blowing agents comprise combinations of water and carbon dioxide. Other preferred blowing agents and blowing agent mixtures include nitrogen, or argon, with or without carbon dioxide. If desired, such blowing agents or blowing agent mixtures can be mixedwith alcohols, hydrocarbons or ethers of suitablevolatility. See for example, U.S. Pat. No. 6,420,442.

Other Components

Such ingredients as extrusion aids (e.g., barium stearate or calcium stearate), peroxide or C—C synergists, acid scavengers (e.g., magnesium oxide or tetrasodium pyrophosphate), dyes, pigments, fillers, stabilizers, antioxidants, antistatic agents, reinforcing agents, and the like can be included in the foam compositions of this invention. If desired, nucleating agents (e.g., talc, calcium silicate, or indigo) to control cell size can be included in the styrenic polymer compositions used in producing the flame retardant expanded or foamed styrenic polymers of this invention. Each of the particular ancillary materials selected for use in the foam compositions of this invention are used in conventional amounts, and should be selected such that they do not materially affect adversely the properties of the finished polymer foam composition for its intended utility.

In one embodiment of this invention the flame retardant used in foiming the foamed or expanded styrenic polymer is one or more bis(2,3-dibromopropyl)polybromophthalates (i.e., the aromatic ring is substituted by 2, 3, or 4 bromine atoms) with or without the copresence of some bis(2,3-dibromopropyl)monobromophthalate. In this embodiment no other flame retardant is employed.

In another embodiment of this invention the sole flame retardant used in forming the foamed or expanded styrenic polymer is one or more bis(2,3-dibromopropyl)polybromophthalates with or without the copresence of some bis(2,3-dibromopropyl)monobromophthalates, and at least one peroxide or C—C synergist such as dicumyl. When employed, the amounts of such peroxide or C—C synergists is typically in the range of about 0.1 to about 0.4 wt % based on the total weight of the polymer composition. It will be noted that the foamed or expanded styrenic polymercompositions of this invention are devoid of synergists employed in unfoamed or unexpanded styrenic polymers such as antimony oxide.

The following Examples are presented for purposes of illustration.

### EXAMPLES 1, 2 AND COMPARATIVE EXAMPLE 3

To illustrate flame retardant effectiveness, polystyrene compositions were prepared and subjected to ASTM Standard Test Method D 2863-87 commonly referred to as the limiting oxygen index (LOI) test. In this test, the higher the LOI value, the more flame resistant the composition. The test specimens were prepared using Styron® 678E polystyrene from The Dow Chemical Company. This material is a general purpose non-flame retarded grade of unreinforced, crystal polystyrene(GPPS). It has a melt flow index at 200 EC and 5 kg pressure of 10 grams per 10 minutes, and an LOI of 18.0.

The flame retardant used in Examples 1 and 2 was bis(2,3-dibromopropyl)tetrabromophthalate without any other flame retardant or flame retardant assistant or synergist. In Comparative Example 3 the test specimens were prepared from the same polystyrene without any additive mixed therewith.

To form the test specimens of Examples 1 and 2 where the flame retardant loadings were 1.03 wt % and 3.1 wt %, respectively, the following procedure was used:

### Compounding—Example 1

1) Using a Haake rheomix 600 machine, 45 g of GPPS is dumped in the mixing chamber heated at 150 EC and the rotor speed is set at 100 rpm.

2) After 2 minutes, 0.57 g of bis(2,3-dibromopropyl)tetrabromophthalate together with 10 more g of GPPS is then added to the molten material. Mixing is continued for 3 more minutes.

3) The rotors are stopped and the mixingchamberis then opened to collect the resultant compounded blend which is cooled down at room temperature.

4) Three 3 batches are produced to have enough material for compression molding plaques.

### Compression Molding—Example 1

Before compression molding, the respective batches are first ground through a 4 mm sieve. Then 115 g of the ground material is poured into a 190×190 mm insert at room temperature. The insert containing the ground material is put between heated platens at 180° C. for 1 minute at about 20 kN. Then a pressure of 200 kN is applied for 7 more minutes. The insert is then cooled between 2 other platens at 20° C. for 8 minutes with a pressure of 200 kN. A plaque of 190×190×2.75(±0.15) mm is then removed from the mould. Two plaques of 95×95 mm and 17 bars of 10×95 mm are cut out of the larger plaque. The bars were used for LOI evaluations.

### Compounding and Compression Molding—Example 2

For the test specimens of Example 2 which used the flame retardant at a higher loading, the same compounding and compression moulding procedure as above was used except that 1.70 g of bis(2,3-dibromopropyl)tetrabromophthalateand 10 g of GPPS were used in compounding step 2).

The results of these tests are summarized in Table 1.

TABLE 1

| Example | Amount of Flame Retardant, wt % | LOI |
|---|---|---|
| 1 | 1.03 | 20.9 |
| 2 | 3.1 | 22.5 |
| 3 (Comparative) | none (neat polystyrene) | 18 |

### EXAMPLE 4 AND COMPARATIVE EXAMPLE 5

Expandable polystyrene beads (EPS) were prepared with and without addition of a flame retardant of this invention. In the procedure for the flame retardant EPS beads, 0.28 g of polyvinyl alcohol (PVA) was dissolved in 200 g of deionized water and poured into a 1-liter glass vessel. Separately, a solution was formed from 0.64 g of dibenzoyl peroxide (75% in water), 0.22 g of dicumylperoxide, and 1.45 g of bis(2,3-dibromopropyl)tetrabromophthalate in200 g of styrene. This latter solution was poured into the vessel containing the PVA solution. The resultant liquidwas charged to a polymerization reactor and mixed with an impeller-type stirrer set at 100 rpm in the presence of a baffle to generate shear in the reactor. The mixture was then subjected to the following heating profile:

From 20 to 90° C. in 45 minutes and held at 90° C for 4.25 hours (first stage operation);

From90 to 130° C. in 1 hour andheldat 130° C. for2 hours (second stage operation); and

From 130 to 20° C. in 1 hour.

At the end of the first stage the reactor was pressurized with nitrogen (2 bars). Once cooled down, the reactor was emptied and the mixture was filtered. The flame retardant beads formed in the process were dried at 60° C. overnight and then sieved to determine bead size distribution. Comparative Example 5 was conducted in the same manner except that no flame retardant additive was used.

Table 2 summarizes the results of this operation.

TABLE 2

| | Bis(2,3-dibromopropyl)- | |
|---|---|---|
| Flame Retardant Used | tetrabromophthalate | None |
| Loading of Flame Retardant, wt % | 0.73 | 0 |
| Yield | 86.4 | 91.2 |
| Particle Size Distribution of Beads, % | | |
| >2 mm | 3.69 | 9.64 |
| From 2 mm to >1.4 mm | 13.73 | 50.65 |
| From 1.4 mm to >1 mm | 66.69 | 33.9 |
| From 1 mm to >710 μm | 12.92 | 3.67 |
| From 710 μm to >500 μm | 2.08 | 0.86 |
| From 500 μm to >250 μm | 0.90 | 1.28 |

It can be seen from the above results that, surprisingly, the distribution of beads in the commercially-desirable range of from just above 710 μm up to 2 mm was actually higher in the case of the flame retarded beads of this invention (93.34%) as compared to the distribution of the beads in the same range made in the same manner but without use of the flame retardant of this invention (88.22%).

Even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients, or if formed in solution, as it would exist if not formed in solution, all in accordance with the present disclosure. It matters not that a substance, component or ingredient may have lost its original identity through a chemical reaction or transformation during the course of such contacting, blending, mixing, orin situ formation, if conducted in accordance with this disclosure.

Each and every patent or publication referred to in any portion of this specification is incorporated in toto into this disclosure by reference, as if fully set forth herein.

This invention is susceptible to considerable variation in its practice. Therefore the foregoing description is not intended to limit, and should not be construed as limiting, the invention to the particular exemplifications presented hereinabove.

1. A flame retardant styrenic polymer foam composition which comprises a styrenic polymer and flame retardant amount of a flame retardant resulting from inclusion in the foam recipe before or during formation of the foam of at least one bis(bromoalkyl)bromophthalate.

2. A composition as in claim 1 wherein each bromoalkyl group of said at least one bis(bromoalkyl)bromophthalate is, independently, a C₃₋₆ bromoalkyl group having 2 or 3 bromine atoms as substituents thereon.

3. A composition as in claim 1 wherein said at least one bis(bromoalkyl)bromophthalate is bis(tribromoneopentyl)tetrabromophthalate or bis(2,3-dibromopropyl)tetrabromophthalate.

4. A composition as in claim 1 wherein said at least one bis(bromoalkyl)bromophthalate is bis(2,3-dibromopropyl)tetrabromophthalate.

5. A composition as in any of claims 1-4 wherein said styrenic polymer is composed of at least 80 wt % of polymerized styrene.

6. A composition as in any of claims 1-4 wherein said styrenic polymer is crystal polystyrene.

7. A composition as in any of claims 1-4 wherein said styrenic polymer foam composition is in the form of an extruded styrenic polymer foam.

8. A composition as in claim 7 wherein said extruded styrenic polymer foam is composed of at least 80 wt % of polymerized styrene.

9. A composition as in any of claims 1-4 wherein said styrenic polymer foam composition is in the form of expandable styrenic polymer beads or granules.

10. A composition as in claim 9 wherein the styrenic polymer of said expandable styrenic beads or granules is composed of an average of at least 80 wt % of polymerized styrene.

11. In a method of preparing an extruded styrenic foam from a foamable molten styrenic polymer mixture, the improvement which comprises including in said mixture a flame retardant amount of at least one bis(bromoalkyl)bromophthalate.

12. The improvement as in claim 11 wherein each bromoalkyl group of said at least one bis(bromoalkyl)bromophthalate is, independently, a C₃₋₆ bromoalkyl group having 2 or 3 bromine atoms as substituents thereon.

13. The improvement as in claim 11 wherein said at least one bis(bromoalkyl)bromophthalate is bis(tribromoneopentyl)tetrabromophthalate or bis(2,3-dibromopropyl)tetrabromophthalate.

14. The improvement as in claim 11 wherein said at least one bis(bromoalkyl)bromophthalate is bis(2,3-dibromopropyl)tetrabromophthalate.

15. In a method of preparing expandable styrenic beads or granules from an expandable styrenic polymer mixture, the improvement which comprises including in said mixture a flame retardant amount of at least one bis(bromoalkyl)bromophthalate.

16. The improvement as in claim 15 wherein each bromoalkyl group of said at least one bis(bromoalkyl)bromophthalate is, independently, a C₃₋₆ bromoalkyl group having 2 or 3 bromine atoms as substituents thereon.

17. The improvement as in claim 15 wherein said at least one bis(bromoalkyl)bromophthalate is bis(tribromoneopentyl)tetrabromophthalate or bis(2,3-dibromopropyl)tetrabromophthalate.

18. The improvement as in claim 15 wherein said at least one bis(bromoalkyl)bromophthalate is bis(2,3-dibromopropyl)tetrabromophthalate.

19. The improvement as in any of claims 11-18 wherein said styrenic polymer mixture is composed of at least 80 wt % of polymerized styrene.

20. A method of increasing the yield of expandable styrenic beads or granules having a particle size in the range of from just above 710 μm up to 2 mm from an expandable styrenic polymer mixture, which method comprises incorporating into the expandable styrenic polymer mixture at least one bis(bromoalkyl)bromophthalate that increases said yield.

21. A method as in claim 20 wherein said at least one bis(bromoalkyl)bromophthalate is bis(2,3-dibromopropyl)tetrabromophthalate.

22. A composition as in claim 1 wherein said at least one bis(bromoalkyl)bromophthalate is at least one bis(2,3-dibromopropyl)polybromophthalate, optionally with the copresence of bis(2,3-dibromopropyl)monobromophthalate, and wherein at least one peroxide or C—C synergist was included in said foam recipe.

23. A composition as in claim 22 wherein said synergist is dicumyl.

24. A composition as in claim 22 wherein the amount of said peroxide or C—C synergist is in the range of about 0.1 to about 0.4 wt % based on the total weight of said styrenic polymer foam composition.

25. The improvement as in claim 11 wherein said at least one bis(bromoalkyl)bromophthalate is at least one bis(2,3-dibromopropyl)polybromophthalate, optionally with the copresence of bis(2,3-dibromopropyl)monobromophthalate, and wherein at least one peroxide or C—C synergist is included in said mixture.

26. The improvement as in claim 25 wherein said synergist is dicumyl.

27. The improvement as in claim 25 wherein the amount of said peroxide or C—C synergist is in the range of about 0.1 to about 0.4 wt % based on the total weight of said extruded styrenic foam.

28. The improvement as in claim 15 wherein said at least one bis(bromoalkyl)bromophthalate is at least one bis(2,3-dibromopropyl)polybromophthalate, optionally with the copresence of bis(2,3-dibromopropyl)monobromophthalate, and wherein at least one peroxide or C—C synergist is included in said mixture.

29. The improvement as in claim 28 wherein said synergist is dicumyl.

30. The improvement as in claim 28 wherein the amount of said peroxide or C—C synergist is in the range of about 0.1 to about 0.4 wt % based on the total weight of said beads or granules.
